(19) United States
(12) Patent Application Publication
(10) Pub. No.: US 2026/0014691 A1
(43) Pub. Date: Jan. 15, 2026

(54) Tool Station With Customizable Shelving

(71) Applicant: Craig Jackson, NICHOLASVILLE, KY (US)

(72) Inventor: Craig Jackson, NICHOLASVILLE, KY (US)

(21) Appl. No.: 19/266,290

(22) Filed: Jul. 11, 2025

Related U.S. Application Data
(60) Provisional application No. 63/669,807, filed on Jul. 11, 2024.

(51) Int. Cl. B25H 1/12; B25H 1/02

(52) U.S. Cl. CPC B25H 1/12; B25H 1/02

(57) ABSTRACT

A tool station includes a frame, a first swinging shelf support pivotally attached to the frame and one or more sliding shelf supports. The tool station also includes a plurality of shelf receivers including at least one shelf receiver carried on the frame, at least one shelf receiver carried on the first swinging shelf support and at least one shelf receiver carried on the sliding shelf supports. Interchangeable collet shelves and tool holder shelves may be attached to the tool station at the various shelf receivers.

### RELATED APPLICATIONS

This document claims the benefit of and priority to U.S. Provisional Patent Application Ser. No. 63/669,807, filed on Jul. 11, 2024, the full disclosure of which is incorporated herein by reference.

### TECHNICAL FIELD

This document relates generally to a tool station for a number of different applications that may be more particularly adapted to organize Computer Numerical Control or CNC collets, tool holders and complete tool assemblies at a conveniently positioned, centralized location in a CNC workshop.

### BACKGROUND

CNC machines for machining a work piece to a desired shape are well known in the art. Such machines use a wide range of different cutting tools to meet the needs of any particular machining application. Each cutting tool is held in a tool holder specific to the CNC machine. The completed tool assembly is then installed by the tool holder in the CNC machine in order to complete the machining task.

It is often necessary to change the cutting tool installed in a CNC machine in order to properly complete the next machining task. In other instances, a worn or broken cutting tool may require replacement. As a result CNC workshops need a large number and variety of different collets, tool holders and completed tool assemblies at a centralized location in the workshop. They also need a convenient place to assemble and disassemble the tool assemblies as required.

This document describes a CNC tool station particularly adapted to organize CNC collets, tool holders and complete tool assemblies for the benefit and advantage of CNC machine operators. The tool station allows one to easily view a large collection of collets, tool holders and completed tool assemblies. The tool station also allows one to easily select and safely retrieve a desired collet, tool holder or completed tool assembly without reaching over and potentially being injured by the sharp cutting tools held in the tool holders. In addition, the tool station includes a workbench where one can quickly and easily assemble and disassemble completed tool assemblies.

### SUMMARY

In accordance with the purposes and benefits set forth herein, the new and improved tool station, comprises, consists of or consists essentially of: (a) a frame, (b) a first swinging shelf support pivotally attached to the frame, and (c) a plurality of shelf receivers including at least one shelf receiver carried on the frame and at least one shelf receiver carried on the first swinging shelf support. Each one of the plurality of shelf receivers may include a support leg and an upwardly projecting tab. While generally useful for holding tools of any type or for other storage applications, the new and improved tool station may be particularly adapted for holding and storing Computer Numerical Control or CNC collets, tool holders and complete tool assemblies at a conveniently positioned, centralized location in a CNC workshop.

In at least one of the many possible embodiments of the tool station, the first swinging shelf support includes a first hinge side attached by a first hinge assembly to the frame and a first free side opposite the first hinge side. The first swinging shelf support may further include a first wheel assembly connected to the first swinging shelf support and adapted to support the first swinging shelf support on a floor of a building structure. More particularly, the first wheel assembly may be positioned toward the first free side to better support the weight of the first swinging shelf support and the collets, tool holders and completed tool assemblies held thereon as the first swinging shelf support is pivoted between open and closed positions.

In at least some embodiments, the tool station further includes a workbench carried on the frame. The workbench may provide a conveniently located workspace for assembling and disassembling completed tool assemblies consisting of collets, collets nuts, tool holders and cutting tools stored at the tool station.

In one or more of the many possible embodiments of the tool station, the tool station further includes at least one sliding shelf support underneath the workbench. At least one shelf receiver is carried on the sliding shelf support. A first guide rail receiver may be carried on an underside of the workbench and a first guide rail may be carried on the at least one sliding shelf support. The first guide rail may be received in and slide freely along the first guide rail receiver. A second guide rail receiver may be carried on the sliding shelf support toward the opposite end. A second guide rail may be carried on the frame, such as near the lower end of the front posts. The second guide rail receiver may be received on and slide freely along the second guide rail.

A second wheel assembly and a third wheel assembly, adapted to support the weight of the sliding shelf support on the floor, may be connected to the sliding shelf support. Such a structural arrangement functions to allow the collets, tool holders and/or completed tool assemblies held on shelves connected to the sliding shelf support to be easily accessed by pulling the sliding shelf support out from under the workbench. At other times, the sliding shelf support and the collets, tool holders and completed tool assemblies held thereon may be conveniently stored out of the way under the workbench.

In at least some embodiments of the tool station, the tool station further includes a collet shelf and a tool holder shelf. The collet shelf may include a plurality of spaced apertures adapted to receive and hold a plurality of CNC collets. The tool holder shelf may include a plurality of open ended apertures adapted to receive and hold a plurality of tool holders. Significantly, the collet shelf and the tool holder shelf are interchangeable and both are adapted to be received and held by one of the plurality of plurality of shelf receivers. In this way, the CNC workshop personnel may customize the storage shelves of the tool station as desired to store the collets, tool holders and completed tool assemblies in the best possible positions for more efficient and effective machine shop operations.

Many possible embodiments of the tool station may include a second swinging shelf support pivotally attached to the frame and at least one shelf receiver carried on the second swinging shelf support. The second swinging shelf support may include a second hinge side attached by a second hinge assembly to the frame and a second free side opposite the second hinge side. A fourth wheel assembly may be connected to the second swinging shelf support. Such a fourth wheel assembly is adapted to support the second swinging shelf support on the floor.

In accordance with yet another aspect, the new and improved tool station comprises, consists of or consists essentially of: (a) a frame, (b) a workbench carried on the frame, and (c) at least one sliding shelf support suspended from the workbench, and at least one shelf receiver carried on the sliding shelf support. In such an embodiment, a guide rail receiver may be carried on an underside of the workbench and a guide rail may be carried on the at least one sliding shelf support. Each one of the plurality of shelf receivers may include a support leg and an upwardly projecting tab. The guide rail may be received in and slide along the guide rail receiver.

The tool station may further include at least two second wheel assemblies connected to the sliding shelf support and adapted to support the sliding shelf support on the floor. In addition, the tool station may include (a) a collet shelf, including a plurality of spaced apertures adapted to receive and hold a plurality of CNC collets, and (b) a tool holder shelf, including a plurality of open ended apertures adapted to receive and hold a plurality of tool holders. The collet shelf and the tool holder shelf may be interchangeable and both may be adapted to be received and held by the at least one shelf receiver.

In accordance with still another possible embodiment, the tool station, comprises, consists of or consists essentially of: (a) a frame including at least one shelf receiver, and (b) a collet shelf including a plurality of spaced apertures adapted to receive and hold a plurality of CNC collets and a tool holder shelf including a plurality of open ended apertures adapted to receive and hold a plurality of tool holders wherein the collet shelf and the tool holder shelf are interchangeable and both adapted to be received and held by the at least one shelf receiver.

In accordance with yet another aspect, a tool station comprises, consists of or consists essentially of (a) a frame including at least one shelf receiver and (b) a collet shelf including a plurality of spaced apertures adapted to receive and hold a plurality of CNC collets and a tool holder shelf including a plurality of open ended apertures adapted to receive and hold a plurality of tool holders wherein the collet shelf and the tool holder shelf are interchangeable and both adapted to be received and held by the at least one shelf receiver and wherein said at least one shelf receiver includes a support leg and an upwardly projecting tab.

In at least some embodiments, a U-shaped slot is defined by the support leg, the upwardly projecting tab and the frame. In at least some embodiments, the collet shelf and the tool holder shelf both include a slot. The slot is adapted to pass over the upwardly projecting tab so that an edge of the collet shelf or tool holder shelf, defining an end of the slot, may be positioned to rest on the support leg behind the upwardly projecting tab to secure an end of the shelf to the frame.

In the following description, there are shown and described several embodiments of the tool station. As it should be realized, the tool station is capable of other, different embodiments and its several details are capable of modification in various, obvious aspects all without departing from the tool station as set forth and described in the following claims. Accordingly, the descriptions should be regarded as illustrative in nature and not as restrictive.

### BRIEF DESCRIPTION OF THE DRAWING FIGURES

FIG. 1 is a front perspective view of the tool station with the swinging shelf supports in the closed positon and the sliding shelf supports in the retracted positon under the workbench.

FIG. 2 is a rear perspective view of the tool station with the swinging shelf supports in the closed positon and the sliding shelf supports in the retracted positon under the workbench.

FIG. 3 is a view similar to FIG. 2 but illustrating how the arms of a pallet jack may be positioned under the frame of the tool station in order to lift and move the entire tool station from one location to another.

FIG. 4 is a front perspective view of the tool station with one of the sliding shelf supports illustrated in the extended position, out from underneath the workbench to allow access to any collets, tool holders and completed tool assemblies that might be held on the collet and tool holder shelves secured to the extended sliding shelf support.

FIG. 5 is a rear perspective view of the tool station with one of the sliding shelf supports illustrated in the extended position, out from underneath the workbench to allow access to any collets, tool holders and completed tool assemblies that might be held on the collet and tool holder shelves secured to the extended sliding shelf support.

FIG. 6 is a perspective view of the tool station similar to FIG. 4 but illustrating both swinging shelf supports in the open position.

FIG. 7 is an end view illustrating how a sliding shelf support is suspended from a guide rail receiver mounted to the underside of the workbench.

FIG. 8 is a detailed end view illustrating how the first or upper guide rail on the sliding shelf support is received and slides in the first or upper guide rail receiver mounted to the underside of the workbench.

FIG. 9 is a detailed end view illustrating how the second or lower guide rail receiver, carried on the sliding shelf support, receives and holds the second or lower guide rail carried on the bench support posts.

FIG. 10A is a detailed top plan view of an open ended aperture in a tool holder shelf adapted to receive and hold a tool holder. FIG. 10 B illustrates how a tool holder is inserted into or removed from the open end of the open ended aperture as well as how the tool holder then rests on its flange when fully received within the open ended aperture. FIG. 10 C is a top plan view of FIG. 10B.

FIG. 11A is a detailed view illustrating a shelf receiver and how a collet shelf or tool holder shelf may be interchangeably mounted to the shelf receiver on the frame, the swinging shelf support or the sliding shelf support.

FIG. 11B is a detailed view illustrating how a shelf is hung by passing a slot in the shelf over a tab.

FIG. 11C is a detailed illustration of a shelf with the upper edge of the slot in the shelf resting on the support leg of the tab and the rear wall of the shelf captured between the tab and the frame.

### DETAILED DESCRIPTION

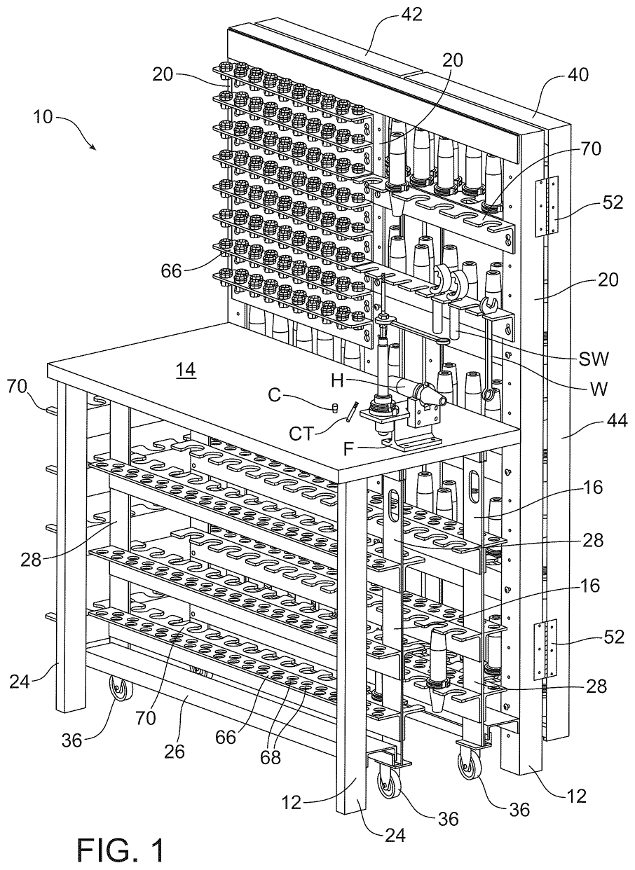

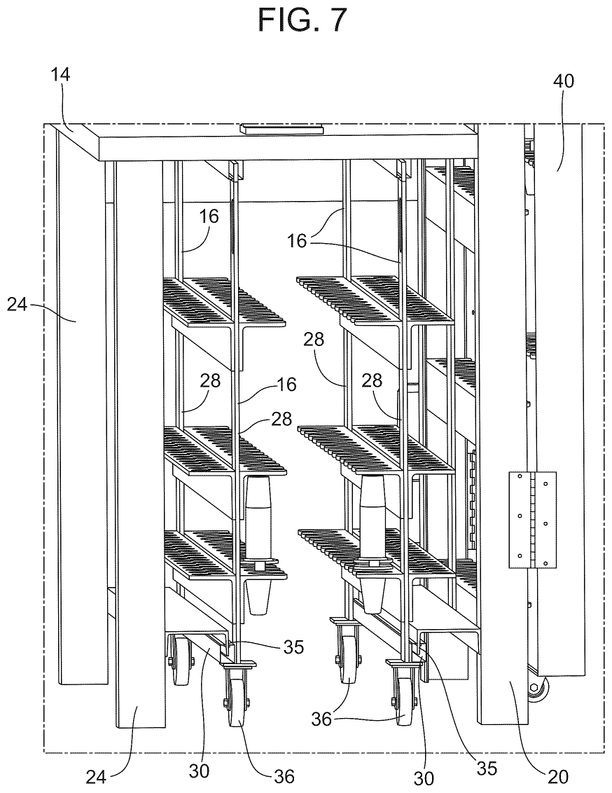

Reference is now made to FIGS. 1-7 illustrating one possible embodiment of the tool station 10 that is particularly adapted for holding CNC collets, tool holders and complete tool assemblies. This includes all types and sizes of CNC milling holders (such as CAT 40 and 50, BT 30 and 40, HSK 63 and 100 and Capto style 3, 4, 5, 6 and 8) as well as all types and sizes of collets (such as ER 11, 16, 20, 25, 30 and 40, TG 50, 75 and 100 and SK 6, 10, 16 and 25). Other embodiments of the tool station 10 may be particularly adapted for other applications including, for example, holding wood working tools, auto mechanic shop tools, gardening and lawn care tools or the like. The illustrated tool station 10 includes a frame 12, a workbench 14, two sliding shelf supports 16, suspended from the underside of the workbench, and two swinging shelf supports 40, 42 pivotally connected to the frame.

The frame 12 includes three support posts 20, connected together by a plurality of cross braces 22 and two bench support posts 24 connected together by a cross member 26. Brackets and fasteners, of a type known in the art and not shown, connect the workbench 14 to both of the support posts 20 and both of the bench support posts 24. The frame 20 may be made from any appropriate, strong structural material such as aluminum or steel. The cross braces 22 may be connected to the two support posts 20 by fasteners of a type known in the art or by welding. The cross member 26 may be connected to the two bench posts 24 by fasteners of a type known in the art or by welding.

The workbench 14, supported by the frame 12, provides a flat work surface for assembling and disassembling completed tool assemblies TA, comprising a cutting tool CT received in a collet C, attached to the tool holder H by means of a collet nut N. A completed tool assembly is shown held in the tool holder fixture F on the workbench 14 in FIGS. 1-7. A crow's foot wrench W for installing a cutting tool CT and a collet C on an Er 16 tool holder and a spanner wrench SW for installing a cutting tool CT and a collet C on an Er 32 tool holder are shown hanging from the cross brace 22 located directly above the upper surface of the workbench where they may be accessed easily when needed.

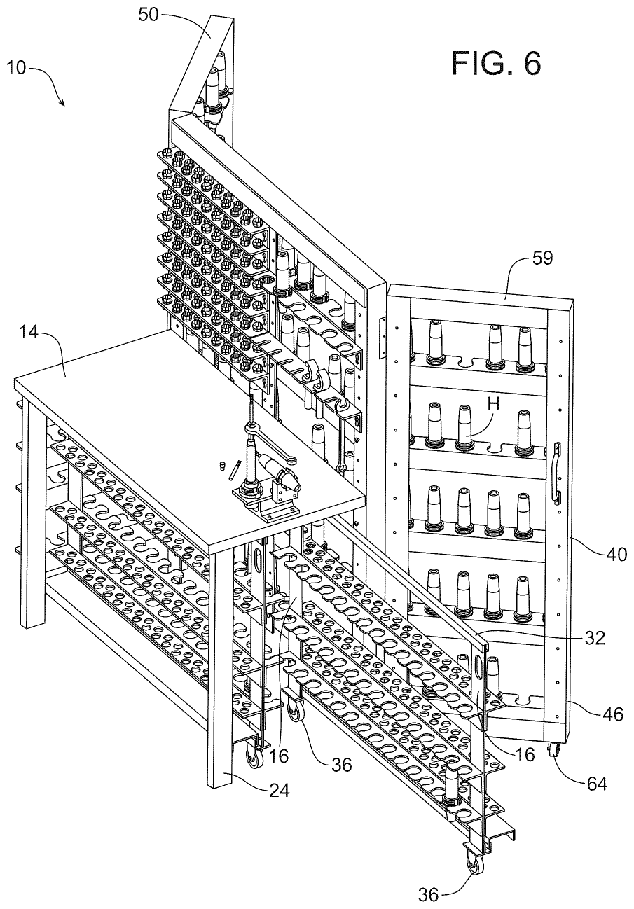

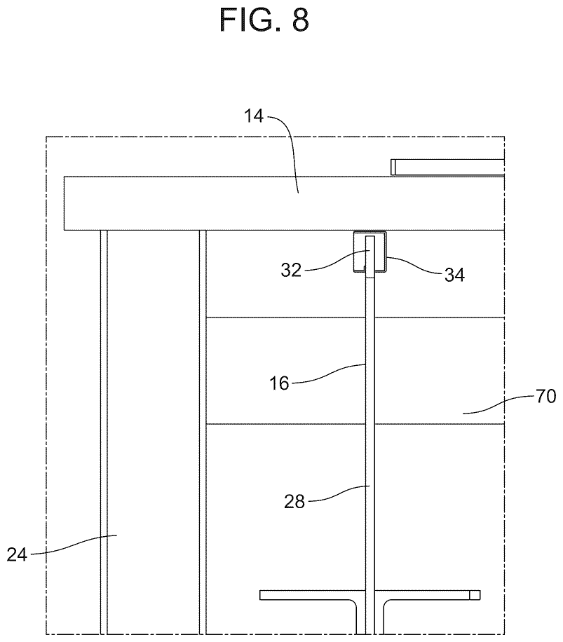

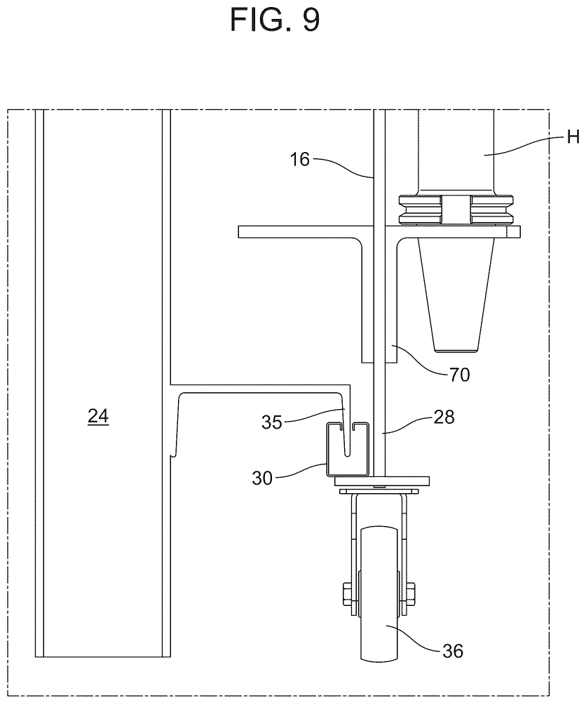

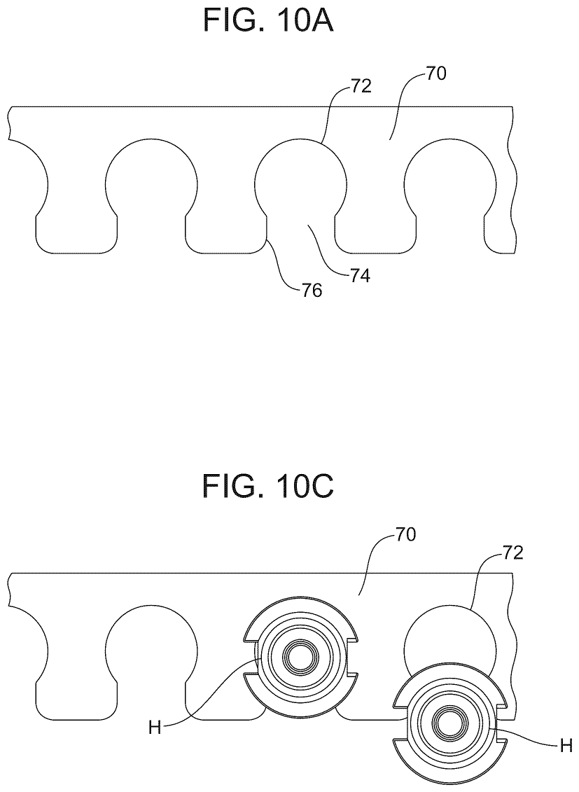

As best shown in FIGS. 6-9, each sliding shelf support 16 includes two uprights 28 connected together at the lower end by a guide rail receiver 30 and connected together at the upper end by a guide rail 32. First guide rail 32 is received for free sliding movement in a first guide rail receiver 34 mounted to the underside of the workbench 14. Second guide rail receiver 30 is received for free sliding movement along the second guide rail 35 mounted to either the bench support posts 24 or the support posts 20. In this way each sliding shelf support 16 is suspended from the workbench 14.

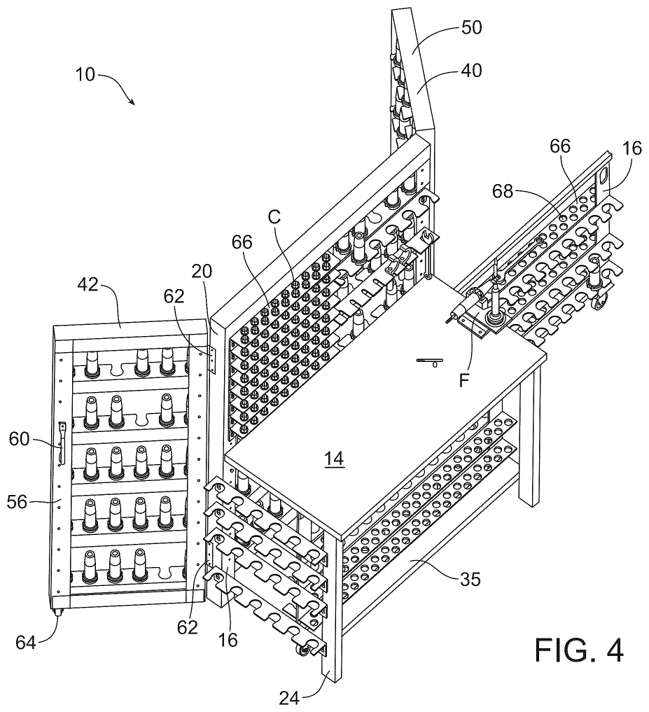

Wheel assemblies 36, of a type well known in the art, are connected to the base rail 30 of each sliding shelf support 16 and function to support the weight of the sliding shelf support and any collets C, tool holders H and completed tool assemblies TA held thereon by rolling across the floor when the sliding shelf support is displaced between the retracted position, under the workbench 14 (see FIGS. 1-3), and the extended position out from under the workbench (Sec FIGS. 4-7). Thus, it should be appreciated that the sliding shelf supports 16 may be extended out from beneath the workbench 14 when seeking to easily access any collet, tool holder or completed tool assembly held thereon. At all other times, the sliding shelf supports 16 may be stored out of the way under the workbench 14. Two sliding shelf supports 16 are provided next to each other in the illustrated embodiment and each may be independently moved between the retracted and extended positions.

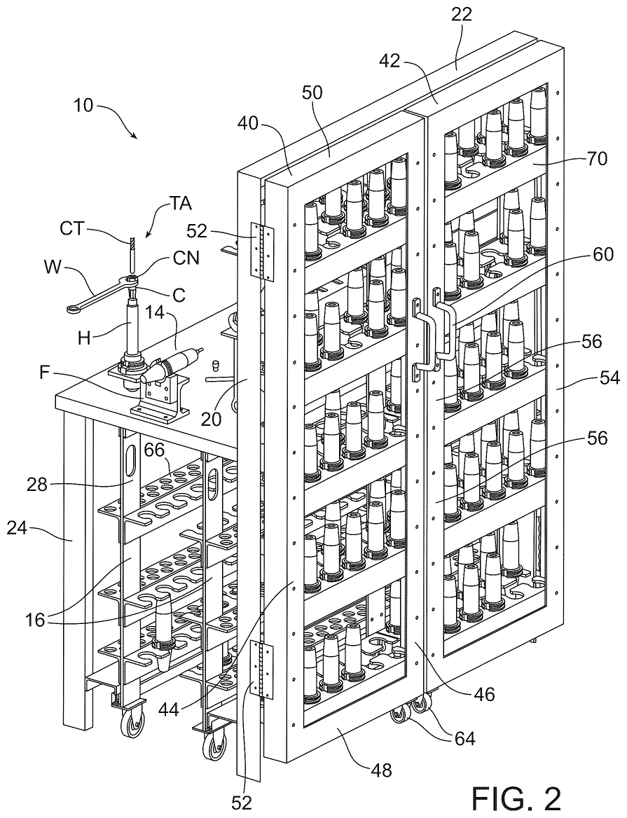

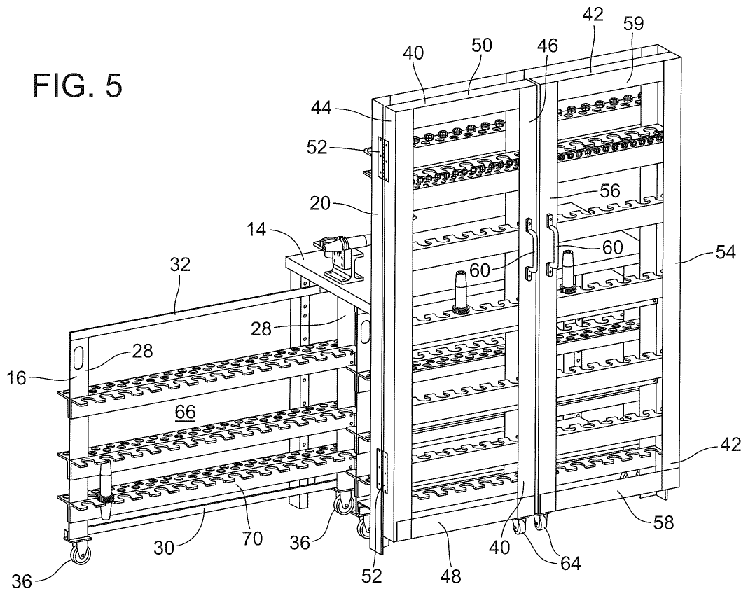

As best shown in FIGS. 2, 5, 6 and 7, the CNC tool station 10 includes two swinging shelf supports 40, 42. The first swinging shelf support 40 includes a first side member 44 (first hinge side) and a second side member 46 (first free side) connected together at the lower ends by a cross brace 48 and at the upper ends by a cross brace 50. The first side member 44 is connected by the first hinge assemblies 52 to one support post 20 of the frame 12. The second swinging shelf support 42 includes a first side member 54 (second hinge side) and a second side member 56 (second free side) connected together at the lower ends by a cross brace 58 and at the upper ends by a cross brace 59. The first side member 54 is connected by the second hinge assemblies 62 to the other support post 20 of the frame 12. FIGS. 2 and 5 illustrate the two swinging shelf supports 40, 42 in the closed position alongside and parallel to the frame 12. FIGS. 4 and 6 illustrate the two swinging shelf supports 40, 42 in the open position where the first and second free sides swing in an arc defined by the hinge assemblies 52, 62 away from the frame 12. Handles 60, provided on the free sides 46, 56, are easy to grasp and provide a convenient way to open and close the swinging shelf supports 40, 42.

Each swinging shelf support 40, 42 includes a wheel assembly 64, of a type known in the art, mounted to the lower cross braces 48, 58 substantially under the free side members 46, 56. The wheel assemblies 64 roll along the floor and function to help support the weight of the swinging shelf supports 40,42 and all of the collets, tool holders and tool assemblies carried thereon. This relieves pressure on the hinge assemblies 52, 62 and aids in smooth opening and closing of the swinging shelf supports 40, 42.

The CNC tool station 10 also includes shelving for receiving and holding collets C, tool holders H and completed tool assemblies TA. More specifically, the CNC tool station 10 includes one or more collet shelves 66 and one or more tool holder shelves 70. Each collet shelf 66 includes a plurality of spaced apertures 68 sized to receive and hold collets C (see, for example, FIG. 4). As shown, the apertures 68 may be provided in two offset rows for both extra capacity on each shelf and case of access to the collets C held in those apertures. Each tool holder shelf 70 includes a plurality of spaced, open-ended apertures 72 adapted to receive and hold tool holders H, including tool holders of completed tool assemblies TA.

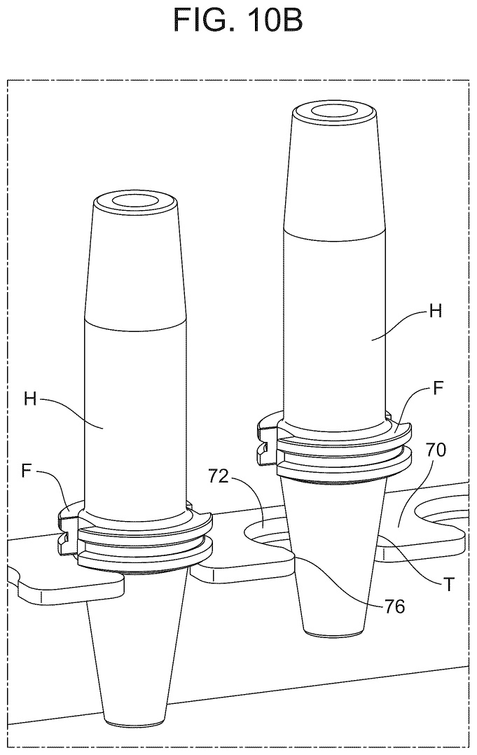

More specifically, as illustrated in FIGS. 10A-10C one places tool holders H on the tool holder shelf 70 by guiding the taper T of the tool holder H through the open end of the aperture 72 and then resting the flange F of the tool holder on the upper surface of the shelf. See the tool holder H on the right in FIGS. 10B and 10C being placed on the tool holder shelf 70 while the tool holder H on the left has been so placed and rests on its flange F. One removes the tool holder H in the opposite manner. Since the taper T of the tool holder H passes through the open side 74 of the aperture 72, it is not necessary to completely lift the tool holder from the aperture 72. This reduces the vertical clearance necessary to remove and replace tool holders H from the shelf 70. This is a significant advantage when one considers the fact that some of the cutting tools CT held in the completed tool assemblies TA are quite long and would otherwise require substantial additional vertical spacing between shelves 68. At the same time, the narrowed neck region 76 of the open-sided aperture 72 aids in retaining the tool holder H in the aperture 72 when the flange F is resting on the shelf 70. This helps keep the tool holders H in the apertures when the sliding shelf supports 16 are being displaced between retracted and extended positions and the swinging shelf supports 40, 42 are being displaced between open and closed positions in order to access or store tool holders H.

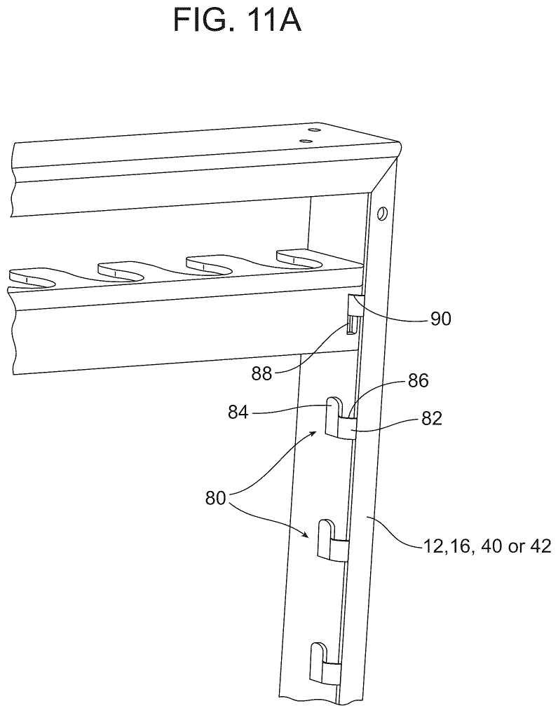

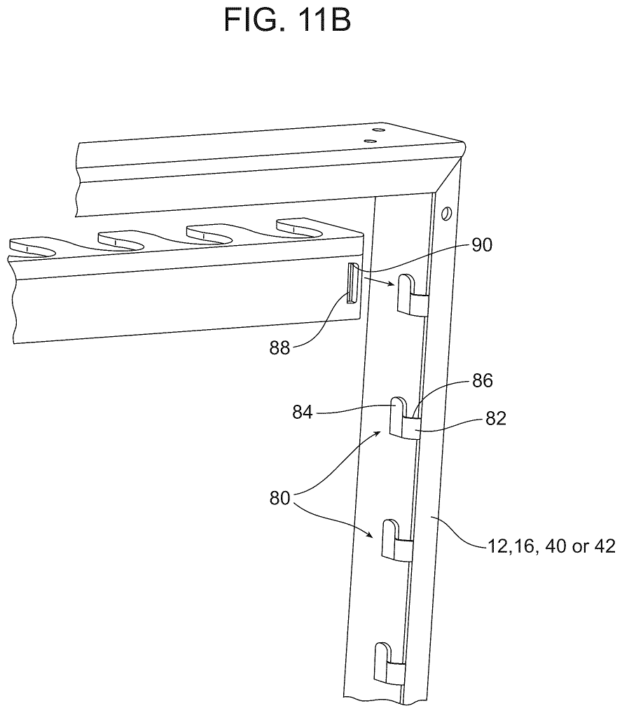

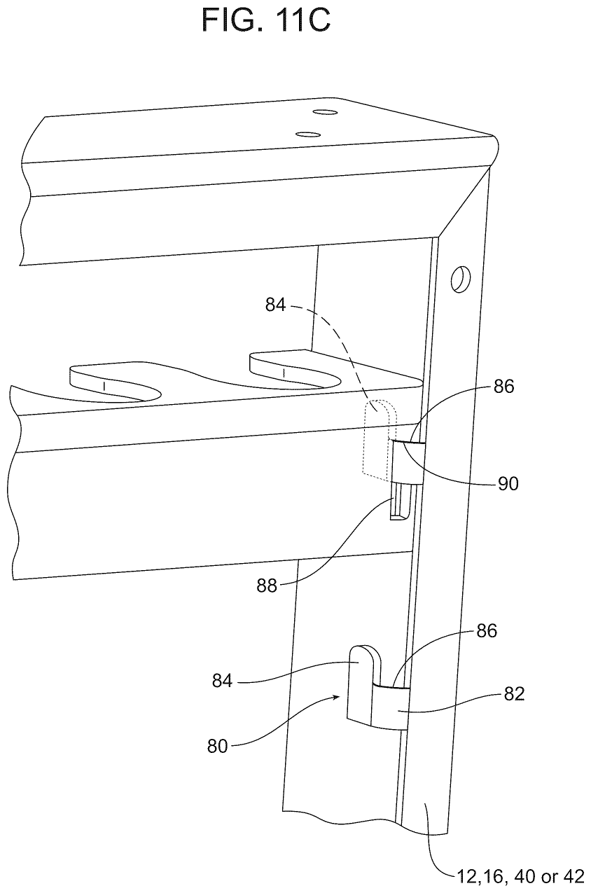

In accordance with another aspect of the CNC tool station 10, as best shown in FIGS. 11A-11C the collet shelves 66 and the tool holder shelves 70 are interchangeable so as to allow one to customize the storage space in accordance with one's needs. More specifically, (a) the posts 20, 24 of the frame 12, (b) the uprights 28 of each sliding shelf support 16, (c) the side members 44, 46 of the first swinging shelf support 40 and (d) the side members 54, 56 of the second swinging shelf support 42 all include shelf receivers 80. Preferably, all of the different shelf receivers 80 share common construction and dimensions to promote interchangeability of the components.

In the illustrated embodiment, the shelf receivers 80 take the form of mounting lugs that are secured to or carried by the frame 12, sliding shelf supports 16 and swinging shelf supports 40, 42. Each shelf receiver/mounting lug 80 projects from the frame 12, sliding shelf supports 16 and swinging shelf supports 40, 42. Each shelf receiver/mounting lug 80 is in the form of a saddle including a support leg 82 and an upwardly projecting tab 84. Together, the support leg 82 and the tab 84 form a substantially U-shaped slot 86 with the frame 12, sliding shelf support 16 or swinging shelf support 40, 42 upon which the mounting lug 80 is carried. The U-shaped slot 86 opens upward when the tool station 10 is properly assembled and supported on the ground or floor.

The collet shelves 66 and the tool holder shelves 70 both include rectangular slots 88 adapted to receive a mounting lug 80. Preferably, all of the different mounting lugs 80 share common construction and dimensions to promote interchangeability of the components. As best shown in FIG. 11B, one installs a shelf 66, 70 on the frame 12, sliding shelf support 16 or swinging shelf support 40, 42 by manipulating the shelf so that the cooperating mounting lugs 80 pass through cooperating slots 88 adjacent the two ends of the shelf. Accordingly, it should be appreciated that the slots 88 and mounting lugs 80 are dimensioned to provide the necessary clearance to allow the connection. As best shown in FIG. 11C, the shelf 66, 70 is then shifted relative to the frame 12 of shelf support 16, 40, 42 so that the margin or edge 90 of the shelf wall defining the top end of the slot 88 rests on the support leg 82 with the tab 84 projecting upwardly behind the shelf wall so that the shelf wall is effectively captured between the tab and the frame 12, sliding shelf support 16 or swinging shelf support 40, 42 to hold the shelf in position. See also FIG. 11A. The shelf receivers 80 and the slots 88 are adapted and spaced to interconnect so that the collet and tool holder shelves 66, 70 may be interchangeably connected to the frame 12, sliding shelf supports 16 and swinging shelf supports 40, 42.

In use, one may connect collet shelves 66 or tool holder shelves 68 to the frame 12, sliding shelf supports 16 and swinging shelf supports 40, 42 at any position where shelf receivers 80 are provided. Thus, the vertical spacing between shelves 66, 68 and the type of shelf (i.e. collet shelf 66 or tool holder shelf 68) may be selected to meet the particular needs of the user. This allows customization of the CNC tool station 10: that is, optimization of the tool station to meet the needs of the user. In use, the workbench 14 allows a convenient place for one to assemble and disassemble completed tool assemblies TA using the fixture F. The tools for that work, including the crow's foot wrench W and the spanner wrench SW, can be easily access hanging on the cross brace 22 or other structure of the CNC tool station 10.

One can pull the sliding shelf supports 16 out from under the workbench 14 as needed to easily access any collet C, tool holder H or completed tool assembly TA carried on the sliding shelf support without having to reach over or around other tool holders or completed tool assemblies which include the sharp cutting tools T. Similarly, one can swing open either or both swinging shelf supports 40, 42 to easily access any particular collet C, tool holder H or completed tool assembly TA carried on the frame 12 or either of the swinging shelf supports without having to reach over or around other tool holders or completed tool assemblies which include the sharp cutting tools T.

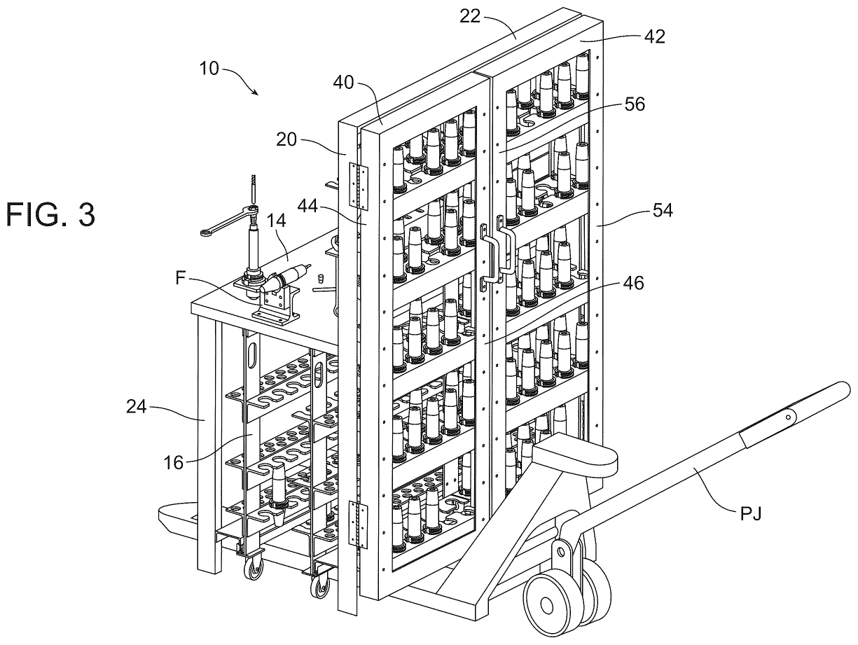

At other times, the sliding shelf supports 16 may be pushed into the retracted position under the workbench 14 and the swinging shelf supports 40, 42 may be closed together against the frame so that all equipment is stored out of the way and the workspace is open to allow freedom of movement in and around the tool station 10. When the sliding shelf supports 16 and the swinging shelf supports 40, 42 are closed, the entire CNC tool station 10 and all of the tools held thereon may be easily lifted and moved to a new location by means of a pallet jack PJ as shown in FIG. 3.

This disclosure may be said to relate to the following items.
1. A tool station, comprising:
   a frame;
   a first swinging shelf support pivotally attached to the frame;
   a plurality of shelf receivers including at least one shelf receiver carried on the frame and at least one shelf receiver carried on the first swinging shelf support wherein each one of said plurality of shelf receivers includes a support leg and an upwardly projecting tab.
2. The tool station of item 1, wherein the first swinging shelf support includes a first hinge side attached by a first hinge assembly to the frame and a first free side opposite the first hinge side
3. The tool station of item 2, further including a first wheel assembly connected to the first swinging shelf support and adapted to support the first swinging shelf support on a floor of a building structure.
4. The tool station of item 3, further including a workbench carried on the frame.
5. The tool station of item 4, further including at least one sliding shelf support underneath the workbench, and at least one shelf receiver carried on the sliding shelf support.
6. The tool station of item 5, further including a guide rail receiver carried on an underside of the workbench and a guide rail carried on the at least one sliding shelf support, the guide rail being received in and sliding along the guide rail receiver.
7. The tool station of item 6, further including a second wheel assembly and a third wheel assembly connected to the sliding shelf support and adapted to support the sliding shelf support on the floor.
8. The tool station of item 7, further including a collet shelf including a plurality of spaced apertures adapted to receive and hold a plurality of CNC collets and a tool holder shelf including a plurality of open ended apertures adapted to receive and hold a plurality of tool holders wherein the collet shelf and the tool holder shelf are interchangeable and both adapted to be received and held by one of the plurality of shelf receivers.
9. The tool station of item 8, further including a second swinging shelf support pivotally attached to the frame and at least one shelf receiver carried on the second swinging shelf support.
10. The tool station of item 9, wherein the second swinging shelf support includes a second hinge side attached by a second hinge assembly to the frame and a second free side opposite the second hinge side and a fourth wheel assembly connected to the second swinging shelf support and adapted to support the second swinging shelf support on the floor.
11. The tool station of item 1, further including a collet shelf including a plurality of spaced apertures adapted to receive and hold a plurality of CNC collets and a tool holder shelf including a plurality of open ended apertures adapted to receive and hold a plurality of tool holders wherein the collet shelf and the tool holder shelf are interchangeable and both adapted to be received and held by one of the plurality of shelf receivers.
12. The tool station of item 1, further including a second swinging shelf support pivotally attached to the frame and at least one shelf receiver carried on the second swinging shelf support.
13. The tool station of item 12, wherein the second swinging shelf support includes a second hinge side attached by a second hinge assembly to the frame and a second free side opposite the second hinge side and a fourth wheel assembly connected to the second swinging shelf support and adapted to support the second swinging shelf support on the floor.
14. A tool station, comprising:
   a frame;
   a workbench carried on the frame; and
   at least one sliding shelf support underneath the workbench, and at least one shelf receiver carried on the sliding shelf support wherein said at least one shelf receiver includes a support leg and an upwardly projecting tab.
15. The tool station of item 14, further including a guide rail receiver carried on an underside of the workbench and a guide rail carried on the at least one sliding shelf support, the guide rail being received in and sliding along the guide rail receiver.
16. The tool station of item 15, further including at least two second wheel assemblies connected to the sliding shelf support and adapted to support the sliding shelf support on the floor.
17. The tool station of item 16, further including a collet shelf including a plurality of spaced apertures adapted to receive and hold a plurality of CNC collets and a tool holder shelf including a plurality of open ended apertures adapted to receive and hold a plurality of tool holders wherein the collet shelf and the tool holder shelf are interchangeable and both adapted to be received and held by the at least one shelf receiver.
18. A tool station, comprising:
   a frame including at least one shelf receiver; and
   a collet shelf including a plurality of spaced apertures adapted to receive and hold a plurality of CNC collets and a tool holder shelf including a plurality of open ended apertures adapted to receive and hold a plurality of tool holders wherein the collet shelf and the tool holder shelf are interchangeable and both adapted to be received and held by the at least one shelf receiver and wherein said at least one shelf receiver includes a support leg and an upwardly projecting tab.
19. The tool station of item 18 wherein a U-shaped slot is defined by said support leg, said upwardly projecting tab and said frame.
20. The tool station of item 19, wherein said collet shelf and said tool holder shelf both include a slot, said slot being adapted to pass over the upwardly projecting tab so that an edge of the collet shelf or tool holder shelf defining an end of the slot may be positioned to rest on said support leg behind said upwardly projecting tab.

Each of the following terms written in singular grammatical form: “a”, “an”, and “the”, as used herein, means “at least one”, or “one or more”. Use of the phrase “One or more” herein does not alter this intended meaning of “a”, “an”, or “the”. Accordingly, the terms “a”, “an”, and “the”, as used herein, may also refer to, and encompass, a plurality of the stated entity or object, unless otherwise specifically defined or stated herein, or, unless the context clearly dictates otherwise. For example, the phrase: “a collet shelf”, as used herein, may also refer to, and encompass, a plurality of collet shelves.

Each of the following terms: “includes”, “including”, “has”, “having”, “comprises”, and “comprising”, and, their linguistic/grammatical variants, derivatives, or/and conjugates, as used herein, means “including, but not limited to”, and is to be taken as specifying the stated component(s), feature(s), characteristic(s), parameter(s), integer(s), or step(s), and does not preclude addition of one or more additional component(s), feature(s), characteristic(s), parameter(s), integer(s), step(s), or groups thereof.

The phrase “consisting of”, as used herein, is closed-ended and excludes any element, step, or ingredient not specifically mentioned. The phrase “consisting essentially of”, as used herein, is a semi-closed term indicating that an item is limited to the components specified and those that do not materially affect the basic and novel characteristic(s) of what is specified.

Terms of approximation, such as the terms about, substantially, approximately, etc., as used herein, refers to ±10% of the stated numerical value.

Although the CNC tool station 10 of this disclosure has been illustratively described and presented by way of specific exemplary embodiments, and examples thereof, it is evident that many alternatives, modifications, or/and variations, thereof, will be apparent to those skilled in the art. For example, rather than including a workbench 14, the tool station 10 could include swinging shelf supports or doors 40, 42 at both sides. Further, the swinging shelf supports 40, 42 may include clear acrylic dust covers to allow viewing of the tools while limiting dust access to the tools. Further, as shown in FIG. 4, the sliding shelf supports 16 slide out to the right of the work bench 14. If the tool station 10 illustrated in FIG. 4 did not include fixed shelves S at the opposite end of the workbench 14, the sliding shelf supports 16 could also slide outward to the left of the workbench. Accordingly, it is intended that all such alternatives, modifications, or/and variations, fall within the spirit of, and are encompassed by, the broad scope of the appended claims.

What is claimed:

1. A tool station, comprising:
a frame;
a first swinging shelf support pivotally attached to the frame;
a plurality of shelf receivers including at least one shelf receiver carried on the frame and at least one shelf receiver carried on the first swinging shelf support wherein each one of said plurality of shelf receivers includes a support leg and an upwardly projecting tab.

2. The tool station of claim 1, wherein the first swinging shelf support includes a first hinge side attached by a first hinge assembly to the frame and a first free side opposite the first hinge side.

3. The tool station of claim 2, further including a first wheel assembly connected to the first swinging shelf support and adapted to support the first swinging shelf support on a floor of a building structure.

4. The tool station of claim 3, further including a workbench carried on the frame.

5. The tool station of claim 4, further including at least one sliding shelf underneath the workbench, and at least one shelf receiver carried on the sliding shelf support.

6. The tool station of claim 5, further including a guide rail receiver carried on an underside of the workbench and a guide rail carried on the at least one sliding shelf support, the guide rail being received in and sliding along the guide rail receiver.

7. The tool station of claim 6, further including a second wheel assembly and a third wheel assembly connected to the sliding shelf support and adapted to support the sliding shelf support on the floor.

8. The tool station of claim 7, further including a collet shelf including a plurality of spaced apertures adapted to receive and hold a plurality of CNC collets and a tool holder shelf including a plurality of open ended apertures adapted to receive and hold a plurality of tool holders wherein the collet shelf and the tool holder shelf are interchangeable and both adapted to be received and held by one of the plurality of shelf receivers.

9. The tool station of claim 8, further including a second swinging shelf support pivotally attached to the frame and at least one shelf receiver carried on the second swinging shelf support.

10. The tool station of claim 9, wherein the second swinging shelf support includes a second hinge side attached by a second hinge assembly to the frame and a second free side opposite the second hinge side and a fourth wheel assembly connected to the second swinging shelf support and adapted to support the second swinging shelf support on the floor.

11. The tool station of claim 1, further including a collet shelf including a plurality of spaced apertures adapted to receive and hold a plurality of CNC collets and a tool holder shelf including a plurality of open ended apertures adapted to receive and hold a plurality of tool holders wherein the collet shelf and the tool holder shelf are interchangeable and both adapted to be received and held by one of the plurality of shelf receivers.

12. The tool station of claim 1, further including a second swinging shelf support pivotally attached to the frame and at least one shelf receiver carried on the second swinging shelf support.

13. The tool station of claim 12, wherein the second swinging shelf support includes a second hinge side attached by a second hinge assembly to the frame and a second free side opposite the second hinge side and a fourth wheel assembly connected to the second swinging shelf support and adapted to support the second swinging shelf support on the floor.

14. A tool station, comprising:
a frame;
a workbench carried on the frame; and
at least one sliding shelf support underneath the workbench, and at least one shelf receiver carried on the sliding shelf support wherein said at least one shelf receiver includes a support leg and an upwardly projecting tab.

15. The tool station of claim 14, further including a guide rail receiver carried on an underside of the workbench and a guide rail carried on the at least one sliding shelf support, the guide rail being received in and sliding along the guide rail receiver.

16. The tool station of claim 15, further including at least two second wheel assemblies connected to the sliding shelf support and adapted to support the sliding shelf support on the floor.

17. The tool station of claim 16, further including a collet shelf including a plurality of spaced apertures adapted to receive and hold a plurality of CNC collets and a tool holder shelf including a plurality of open ended apertures adapted to receive and hold a plurality of tool holders wherein the collet shelf and the tool holder shelf are interchangeable and both adapted to be received and held by the at least one shelf receiver.

18. A tool station, comprising:
a frame including at least one shelf receiver; and
a collet shelf including a plurality of spaced apertures adapted to receive and hold a plurality of CNC collets and a tool holder shelf including a plurality of open ended apertures adapted to receive and hold a plurality of tool holders wherein the collet shelf and the tool holder shelf are interchangeable and both adapted to be received and held by the at least one shelf receiver and wherein said at least one shelf receiver includes a support leg and an upwardly projecting tab.

19. The tool station of claim 18 wherein a U-shaped slot is defined by said support leg, said upwardly projecting tab and said frame.

20. The tool station of claim 19, wherein said collet shelf and said tool holder shelf both include a slot, said slot being adapted to pass over the upwardly projecting tab so that an edge of the collet shelf or tool holder shelf defining an end of the slot may be positioned to rest on said support leg behind said upwardly projecting tab.
